(19) United States
(12) Patent Application Publication
(10) Pub. No.: US 2007/0206898 A1
(43) Pub. Date: Sep. 6, 2007

(54) OPTICAL EQUALIZATION FILTERING OF DWDM CHANNELS

(75) Inventors: Ting WANG, PRINCETON, NJ (US); Lei XU, PRINCETON, NJ (US); Philip Nan JI, PLAINSBORO, NJ (US); Shuji MURAKAMI, ASHBURN, VA (US); Yutaka YANAO, CHIBA (JP); Tsutomu TAJIMA, TOKYO (JP)

Correspondence Address: BROSEMER, KOLEFAS & ASSOCIATES, LLC (NECL), ONE BETHANY ROAD BUILDING 4 - SUITE #58, HAZLET, NJ, 07730, US

(73) Assignee: NEC LABORATORIES AMERICA, Princeton, NJ (US)

(21) Appl. No.: 11/619,499

(22) Filed: Jan. 3, 2007

Related U.S. Application Data
(60) Provisional application No. 60/743,089, filed on Jan. 3, 2006.

(51) Int. Cl. G02B 6/28

(52) U.S. Cl. 385/24

(57) ABSTRACT

An optical equalization filter and method for simultaneously suppressing inter-symbol interference within a number of dense wavelength division multiplexed channels contained within a DWDM signal wherein the filter may be positioned in any of a number of locations within a DWDM system such that an entire channel therein exhibits a raised cosine function.

### CROSS REFERENCE TO RELATED APPLICATIONS

This invention claims the benefit of U.S. Provisional Application No. 60/743,089 filed 3 Jan. 2006 the entire file wrapper contents of which are incorporated by reference as if set forth at length herein.

### FIELD OF THE INVENTION

This invention relates generally to the field of telecommunications systems and in particular to periodic optical equalization filtering that when applied to an optical network in an end-to-end manner simultaneously suppresses Inter-Symbol Interference (ISI) in multiple dense wavelength division multiplexed (DWDM) channels.

### BACKGROUND OF THE INVENTION

With an increased demand for new telecommunications services such as online gaming, and on-demand video services comes an increased need for communications bandwidth. Accordingly, the incentives for carriers to deploy next-generation DWDM transmission systems operating at 40 Gb/s and beyond are great.

Unfortunately however, upgrading existing DWDM networks from 10 Gb/s to 40 Gb/s, presents a number of technical challenges. For example, one such challenge is eliminating inter-symbol interference (ISI) caused by narrow band filtering of optical multiplexers and demultiplexers. The ISI causes signal energy to be extended onto neighboring time slots which results in transmission errors.

One prior art attempt to mitigate intersymbol interference was described in U.S. Published Patent Application No. 2006/0067695 entitled “Method and Apparatus For Mitigating Intersymbol Interference From Optical Filtering”. According to that application, intersymbol interference (ISI) is mitigated by filtering multichannel optical signals using an optical filter device that exhibits a desired loss ripple in the transmittance profile of the filter passband. More particularly, a special kind of loss ripple that generates a transmittance dip in a filter's passband was used to mitigate a penalty associated with narrow-band optical filtering.

### SUMMARY OF THE INVENTION

In accordance with the present invention a periodic optical equalization filter simultaneously suppresses Inter-Symbol Interference (ISI) associated with multiple channels in a dense wavelength division multiplexed optical communications system.

Advantageously, and in sharp contrast to the prior art, filters constructed according to the present invention are applied to effect the characteristics of an overall transmission path while being positionable anywhere therein. More particularly, filters according to the present invention are designed such that am entire channel exhibits a raised cosine function. Consequently, parallel processing of multiple channels is made possible according to the present invention while lowering overall system cost and reducing device inventories.

An exemplary device—according to the present invention—is constructed from a Fabry-Perot interferometer which may be used as an equalizer for mulple DWDM channels on ITU grids.

### BRIEF DESCRIPTION OF THE DRAWING

Further features and advantages of the present invention will become apparent to those skilled in the art with reference to the drawing in which:

FIG. 1 is a schematic illustration of a generic DPSK system;

FIG. 2 is a schematic illustration of an optical delay interferometer having Michaelson 2(A) and Mach-Zehnder 2(B) structures;

FIG. 3(A), FIG. 3(B) and FIG. 3(C) show in schematic form common DWDM transmitter/receiver configurations;

FIG. 4 is a graph showing power vs. optical frequency for simulated transmissions according to the present invention;

FIG. 5 is a series of optical spectra and eye diagrams for 43 Gb/s 33% RZ DPSK signals with pseudo-random bit sequence (PRBS) modulations;

FIG. 6 shows the relationship between an actual channel and that filtered by equalization filter according to the present invention;

FIG. 7 is a series of waveforms showing the cumulative effects of AWG, Interleaver, and Optical Equalizer on an input waveform;

FIG. 8 is a graph showing Power vs. Optical Frequency for 188.45 THz signal (8A) and an eye diagram for a received 43 GHz DQPSK signal (8B);

FIG. 9 is a graph showing the insertion loss for a periodic comb filter;

FIG. 10 is a schematic of an interferometer showing input waves, reflected waves and transmitted waves;

FIG. 11 is a series of graphs showing a light intensity transmission curve and phase change for different settings of mirror transmission coefficient wherein the depth of the transmission coefficient dip at the center of ITU wavelengths is 1.7 dB, 3.5 dB and 5.4 dB for mirror transmission coefficients of 0.9, 0.8 and 0.7, respectively for 11(A), 11(B), and 11(C);

FIG. 12 is a schematic showing a VPI simulation layout according to the present invention;

FIG. 13 is a series of graphs showing intensity transmission and group delay curves of the AWG and optical interleaver used in the simulation of FIG. 12;

FIG. 14 is a series of eye diagram graphs after equalization according to the present invention;

FIG. 15; is a series of graphs showing the filtered signal(s) according to the present invention and

FIG. 16 is a series of graphs showing eye diagrams for signals after equalization according to the present invention.

### DETAILED DESCRIPTION

The following merely illustrates the principles of the invention. It will thus be appreciated that those skilled in the art will be able to devise various arrangements which, although not explicitly described or shown herein, embody the principles of the invention and are included within its spirit and scope.

Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

By way of further background, it is readily understood by those skilled in the art that because optical dense wavelength division multiplexed (DWDM) communication systems employ light at different wavelengths to carry data information for different channels, the total information-carrying capacity of a single optical fiber is increased by several orders of magnitude as compared with non-DWDM systems. As a result, such systems have found widespread adoption as the increasing demand for communication bandwidths have been accompanied by increased DWDM capacities from 622 Mb/s (OC-12), to 2.488 Gb/s (OC-48) to 9.952 Gb/s (OC-192). Presently, 40 Gb/s and beyond signal transmission per DWDM channel is anticipated.

As compared with 10 Gb/s optical transmission, when upgrading existing systems to 40 Gb/s using conventional on-off-keying (OOK) modulation, there is a much smaller tolerance for fiber chromatic dispersion (CD) and polarization mode dispersion (PMD). Consequently such upgraded systems require a higher optical signal-noise-ratio and exhibit a much broader spectral width.

Alternative modulation formats have been employed in 40 Gb/s signal transmission systems to enable longer transmission distances or higher spectral efficiencies. Such formats include return-to-zero (RZ) OOK, duobinary/phase-shaped binary transmission, differential phase shift keying (DPSK), and differential quadrature phase shift keying (DQPSK). Of these, formats, optical DPSK has become a popular candidate for 40 Gb/s DWDM transmission due in part to its tolerance to fiber nonlinearities and higher receiver sensitivity.(See, e.g., D. F. Grosz, et al, “5.12 Tbit/s (128*42.7 gbit/s) transmission with 0.8 bits/s/Hz spectral efficiency over 1280 km of standard single mode fiber using all-Raman amplification and srong signal filtering”, ECOC 2002, PD4.3, 2002; G. Charlet, et al, “Cost-optimized 6.3 Tbit/s capacity terrestrial link over 17*100 km using phase-shaped binary transmission in a conventional all-EDFA SMF-based system”, OFC 2003, PD25-1, 2003; B. Zhu, et al, “6.4 Tb/s (160*42.7 Gbit/s) transmission with 0.8 bits/s/Hz spectral efficiency over 32*100 km of fiber using CSRZ-DPSK format”, OFC 2003, PDP19-1, 2004; A. H. Gnauck, et al, “Spectral efficiency (0.8 b/s/Hz) 1 Tb/.s (25*42.7 Gb/s) RZ-DQPSk transmission over 28 100-km SSMF with 7 optical add.drops”, ECOC 2004, Th4.4.1, 2004; A. H. Gnauck, P. J. Winzer, “Optical phase-shift-keyed transmission”, Journal of Lightwave Technology, v23, pp115-130, 2005)

As is understood by those skilled in the art, one of the challenges for 40 Gb/s optical DPSK transmission is caused by channel limitations associated with 50 GHz spacing DWDM systems. Addressing the problem, the International Telecommunication Union (ITU) has standardized specific wavelengths with fixed channel spacing for commercial DWDM networks—which are known in the art as the “ITU frequency grids.” According toe the ITU grids, standard channel spacing can be 100 GHz or 50 GHz.

In order to support a greater number of channels within a given spectral band, many of the DWDM systems now deployed utilize 50 GHz as the standard channel spacing. As is understood by those skilled in the art, when the bit rate per channel in a particular DWDM system is 10 Gb/s or lower, the optical signal spectral width is much smaller than the ITU grid channel spacing of 50 GHz. When the channel bit rate is increased to 40 Gb/s, the optical spectral width for 33% return-to-zero (RZ) DPSK modulation is about 60 GHz (for 3 dB bandwidth) or 100 GHz (for 10 dB bandwidth).

When DWDM channel spacing is 50 GHz, the optical multiplexing/demultiplexing elements used the DWDM system—such as the arrayed waveguide gratings and optical interleavers—can cause strong optical filtering effect to the 40 Gb/s DPSK signals. The 50 GHz filtering effect can cause broadening of the 40 Gb/s optical signals, which results in the extension of signal energy into the time slots of neighboring bits. This phenomenon is known as the inter-symbol interference (ISI) and it can cause a dramatic increase of signal bit error rate.

A number of methods have been proposed to solve this ISI problem caused by strong filtering effect when transmitting 40 Gb/s signals using 50 GHz channel spacing. One particularly efficient method involves reducing the signal spectral width to fit into the 50 GHz spacing at the transmitter side. In addition, special coding and modulation methods, such as duobinary and DQPSK, advantageously reduce the optical spectral width of 40 Gb/s signals to be within 50 GHz. Unfortunately however, optical signals generated by duobinary modulation—which is based on partial response signal generation—has a poor extinction ratio and does not exhibit a tolerance to fiber nonlinearities (See, e.g., X. Liu, “Can 40-Gb/s Duobinary Signals be Carried Over Transparent DWDM Systems With 50-GHz Channel Spacing?”, IEEE Photonics Technology Letters, v17, pp1328, 2005).

DPSK Modulation for 40 Gb/s Optical Communication Systems

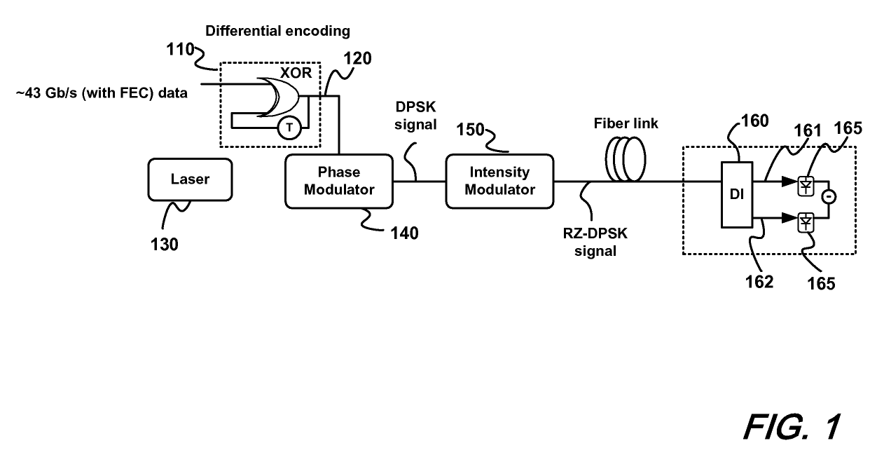

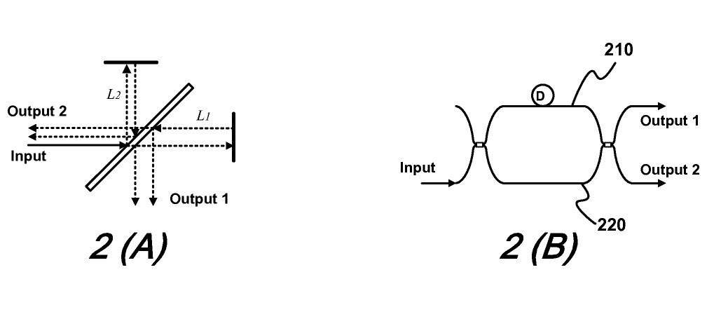

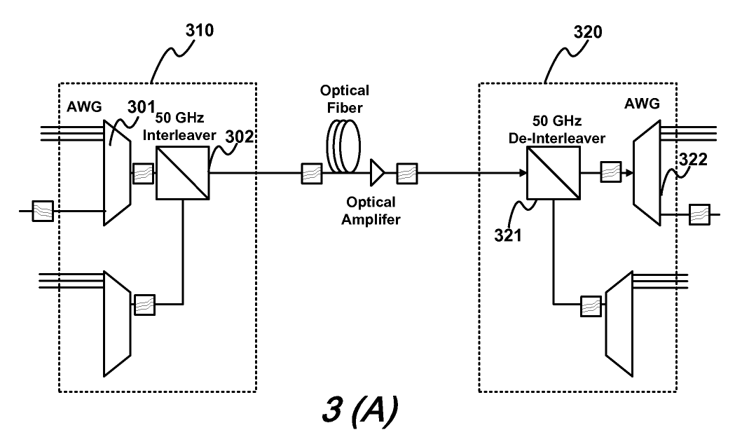

As is known by those skilled in the art, DPSK modulated signals exhibit equalized amplitude and can advantageously reduce the influence of nonlinear effects due to random power fluctuations. A generic architecture of binary DPSK systems is shown in FIG. 1. With reference to that FIG. 1, an input data signal is 110 differentially encoded through one-bit-delay exclusive OR operation 120. The encoded data modulate the phase of light output from a continuous wave laser 130 through the effect of a phase modulator 140.

The output of the phase modulator 140, is typically a NRZ-DPSK signal, where the phase change exists in a whole bit period. However, since phase modulation does not occur instantaneously, chirp (where phase changes with time) occurs during bit transitions. As is known, chirp causes extra spectral broadening of the signal, and can result in more dramatic dispersion during signal transmission in fiber.

A clock driven intensity modulator 150 can be used to carve pulses out of the phase-modulated signal, thus eliminating the part of the signal with chirp. The generated signal is known as return-to-zero (RZ) DPSK signal, and it has been shown to be appropriate for high-speed, long distance transmission. Depending on the modulation bias of the intensity modulator 150 driven by the clock signals, generated RZ-DPSK signals can have duty cycles of 33%, 50%, and 67%.

The DPSK signal output by the intensity modulator 150 can be received with a delay interferometer (DI) 160 and a balanced detector 165. A DI 160 such as that shown, uses the interference between a current bit and a preceding bit and converts the phase modulated signal into intensity modulated signal.

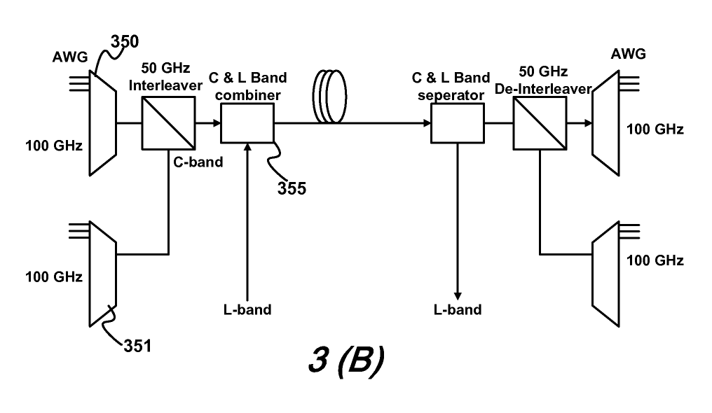

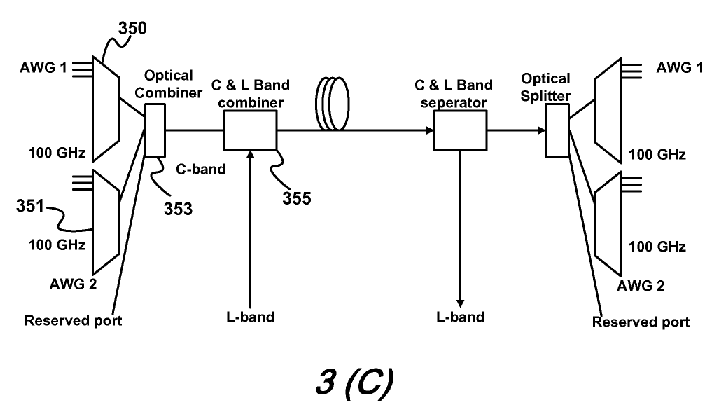

A balanced detector 165 can advantageously use two output ports 161, 162 from the DI (known in the art as the “constructive port” and “destructive port”) and improve the sensitivity of the receiver. Advantageously, a DI can be constructed employing Mach-Zehnder FIG. 2(A) or Michelson FIG. 2(B) interferometers, as shown in FIG. 2.

With reference to that FIG. 2, the delay difference between the two arms 210, 220 of MZDI is typically one bit period to guarantee the maximal overlap of neighboring bits for interference. In DWDM DPSK transmission systems, each one of the individual channels which are at different wavelengths generally require precise tuning of the optical delay for interference. Importantly, and as shown by the inventors of the instant application, the DPSK demodulator can be made “colorless” for DWDM channels on ITU grids by setting the free spectral range (FSR) of the delay interferometer to be the same as ITU channel spacing. Such a “colorless” demodulator is described in U.S. patent application Ser. No. ______ filed on ______ by the applicants of the present invention, the entire contents of which are incorporated herein by reference. As described therein, the requisite conditions for “colorless” DPSK demodulators is that the signal bit rate should be close to the ITU channel spacing, and a large mismatch can cause dramatic degradations of the demodulated signals.

Inter-symbol Interference (ISI) Due to Optical Filtering

In DWDM systems, optical channels transmitted at different wavelengths are combined at the transmitter side and sent through a single piece of fiber. At the receiver end, the combined channels are demultiplexed through the effect of optical filtering devices. FIG. 3 shows two kinds of DWDM multiplexing and demultiplexing schemes which are in present use.

With reference to FIG. 3 (A), at a transmitter 310 side, odd and even channels which are at 100 GHz channel spacing are first multiplexed by a 100 GHz arrayed waveguide grating (AWG) 301, then combined through the effect of an optical interleaver 302 to form DWDM signals exhibiting 50 GHz spacing.

At the receiver 320 side, a 50 GHz optical de-interleaver 321 separates the received DWDM signals into an even band and an odd band which are likewise set at 100 GHz spacing. The even and odd bands are further demultiplexed by 100 GHz AWG filters 322. As can be readily appreciated by those skilled in the art, the architecture depicted in this FIG. 3 (A) are based on 50 GHz DWDM technologies, and have the advantages of high spectral efficiency and low insertion loss which advantageously results from the use of optical interleaver 302).

With simultaneous reference now to FIG. 3(B) and FIG. 3(C) there it shows that different wavelength bands from AWGs 350, 351 are further combined by optical combiners/couplers 353, 355. This multi-port optical combiner 353 generally has higher insertion loss than an optical interleaver (for port number no less than 4). Advantageously, this DWDM multiplexing architecture shown in FIG. 3(C) supports “pay-as-you-grow” business strategy.

As can be appreciated, when upgrading an existing DWDM network to 40 Gb/s or beyond, the DWDM architecture(s) shown in FIGS. 3(B) and 3(C) provides greater flexibility for choosing optical multiplexers and demultiplexers thereby permitting greater performance characteristics for 40 Gb/s signals. Unfortunately however, an undesirable characteristic of the DWDM systems having an architecture such as that shown in FIG. 3(A) in conjunction with 50 GHz spacing, is strong filtering effects to the 40 Gb/s DPSK signals, which results in the signal pulse broadening. As a result, signals received at the receiver end are not longer distinguishable as well-defined pulses. Instead, the energy from a broadened pulse “leaks” into neighboring bit periods, causing inter-symbol interference (ISI).

As is known, a digital modulated signal can be expressed as

$$v ( t ) = {\sum }_{n} {I}_{n} g ( t - nT ) \qquad [ 1 ]$$

where Iₙ represents the discrete information-bearing sequence of symbols and g(t) is the signal pulse. A baseband communication channel with strong filtering effect can be characterized as a band-limited channel with low-pass frequency response C(ƒ). Its equivalent low pass impulse response is expressed as c(t). If a digital modulated signal is transmitted over a band pass channel, the received signal becomes:

$${r}_{l} ( t ) = {\int }_{- ∞}^{+ ∞} v ( τ ) c ( t - τ ) ⅆ τ + z ( t ) \qquad [ 2 ]$$

where z(t) is the additive noise. The signal term can also be represented in the frequency domain as V(ƒ)·C(ƒ), where V(ƒ) is the Fourier transform of ν(t).

If the channel is band-limited to W Hz, then C(ƒ)=0 for |ƒ|>W. As a consequence, any frequency components in V(ƒ)above |ƒ|=W will not be passed by the channel (or exhibit a very large attenuation). Within the bandwidth of the channel, we may express the frequency response C(ƒ) as:
C(ƒ)=|C(ƒ)|e^{jθ(ƒ)} [3]
where |C(ƒ)| is the amplitude-response characteristic and θ(ƒ) is the phase-response characteristic.

A channel is defined as non-distorting or ideal if the amplitude response |C(ƒ)| is constant for all |ƒ|≦W and θ(ƒ) is a linear function of frequency. On the other hand, if |C(ƒ)| is not constant for all |ƒ|≦W, the channel distorts the transmitted signal V(ƒ) in amplitude. And if θ(ƒ)is not linear, the channel distorts the signal V(ƒ)in delay. As a result this amplitude and delay distortion caused by the non-ideal channel frequency-response characteristic C(ƒ), a sequence of pulses transmitted through the channel at rates comparable to the bandwidth Ware spread and overlap, and thus generate ISI.

As an example of the effect of ISI caused by optical filtering on 40 Gb/s signals, we simulate the optical spectra and eye diagrams of 43 Gb/s (the bit rate is for OC-768 with Forward Error Correction) DPSK signals under different optical filtering cases with AWGs and optical interleavers. The AWG filter is a Gaussian type, and its transfer function is defined by:

$$T ( f ) = exp ( - ln \sqrt{2} {( \frac{f - {f}_{c}}{{f}_{g}} )}^{2 n} ) \qquad [ 4 ]$$

where ƒ_{c} is the central frequency, and the 3 dB bandwidth is 2ƒ_{g}. In our simulation we choose n=1 for first-order filters. With higher orders of n, the flatness of the passing band can be increased.

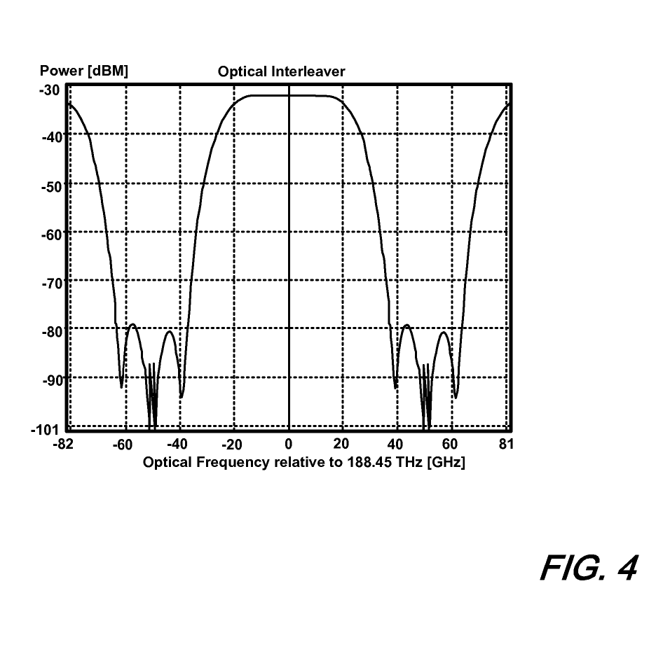

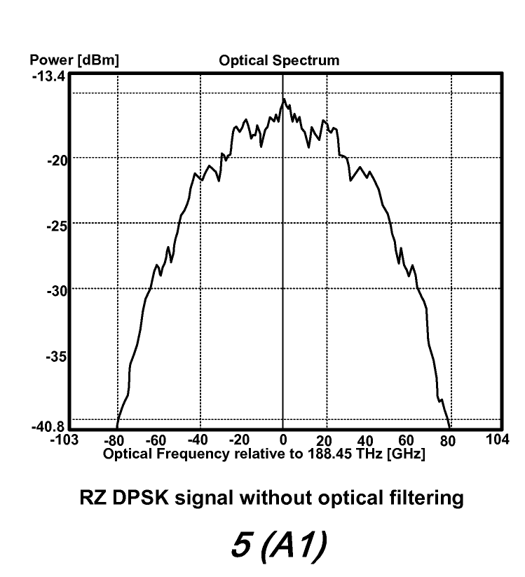

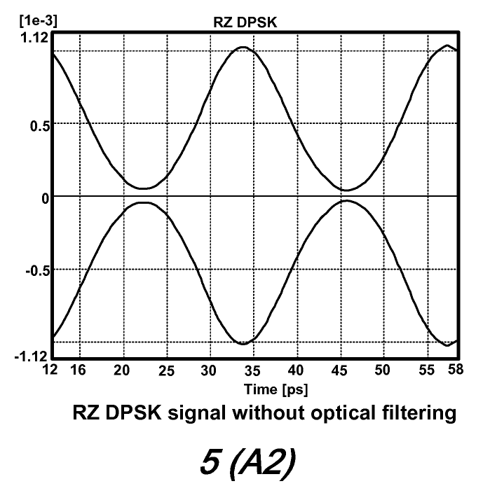

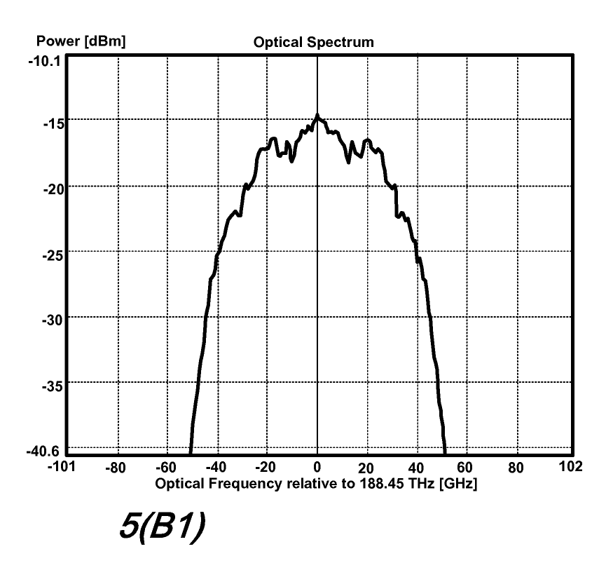

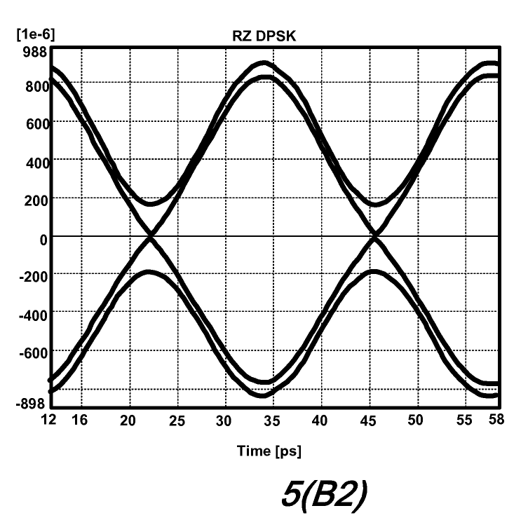

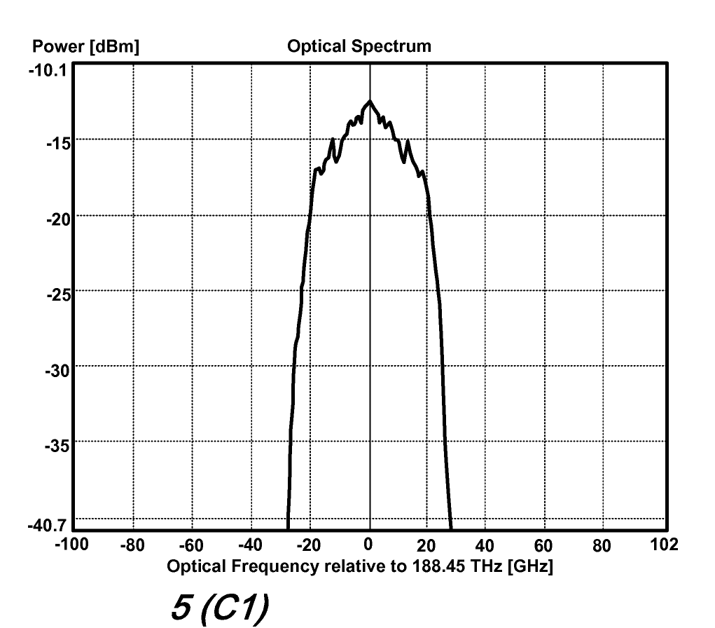

Turning now to FIG. 4, there is shown a graph depicting an intensity transmission curve of the optical interleaver for our simulation is shown, which is based on the characteristics of real devices. As is known, optical interleavers exhibit periodic passing bands which have a flat top and relatively sharp edges. Such optical interleavers can be used to combine odd and even channels with very small insertion loss.

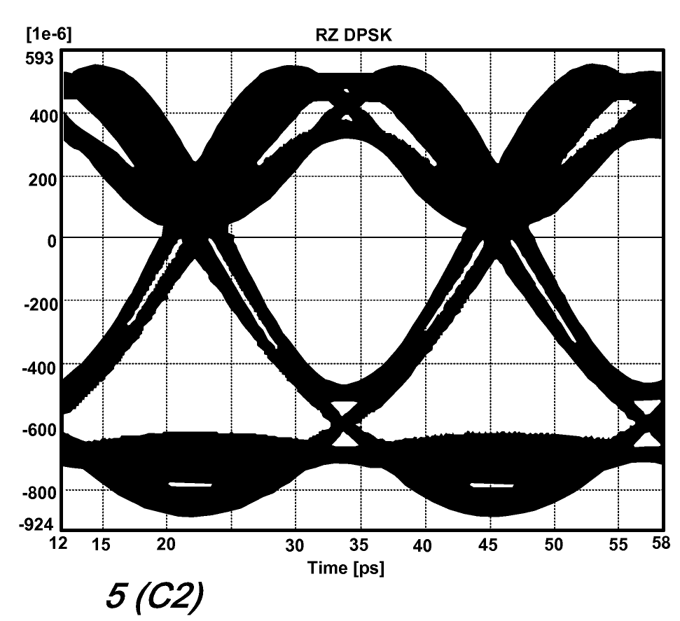

FIG. 5 shows a series of optical spectra and eye diagrams for 43 Gb/s 33% RZ DPSK signals with pseudo-random bit sequence (PRBS) modulations. The 33% RZ DPSK signal has spectral width of 60 GHz (for 3 dB bandwidth), 80 GHz (for 5 dB bandwidth) or 100 GHz (for 10 dB bandwidth). Without any optical filtering, the signal eye diagram has a clear eye opening, as shown in FIG. 5(A).

After the 43 Gb/s signal passes through optical multiplexer and demultiplexer (consisting of AWGs and optical interleavers) in a 100 GHz-channel spacing DWDM system, FIG. 5(B) shows the signal with small degradations due to ISI noise.

Finally, when the signal passes through optical multiplexer and demultiplexer in a 50 GHz channel spacing DWDM system, the signal suffers serious degradations due to strong ISI (shown in FIG. 5(C)), since the channel bandwidth limitation is very close to the signal bit rate. The first-order Gaussian transmission characteristic of AWGs does not have a flattop passing band which adds extra non-ideal signal distortions.

ISI Suppression in Optical Band Limited Channels

According to the present invention, we suppress ISI through an equalization scheme using filters. The underlying principle is based on the theorem of Nyquist criteria which states in part that the pulse s(t) satisfies:

$$s ( lt ) = \{ \begin{matrix}1 & if l = 0 \\ 0 & if l \neq 0\end{matrix} \qquad [ 5 ]$$

If and only if the transform S(ƒ) satisfies:

$$\frac{1}{T} {\sum }_{n = - ∞}^{∞} S ( f + \frac{n}{T} ) = 1 \vert f \vert \leq 1 / 2 T \qquad [ 6 ]$$

When the signal pulses satisfy the Nyquist criteria, and the sampling time exhibits proper settings, there is no ISI. Particularly useful Nyquist pulses are those whose Fourier transforms follow the shape of raised-cosine. Therefore, the ideal transfer function for a band limited channel is raised-cosine, which does not necessarily cause strong ISI for the received signals.

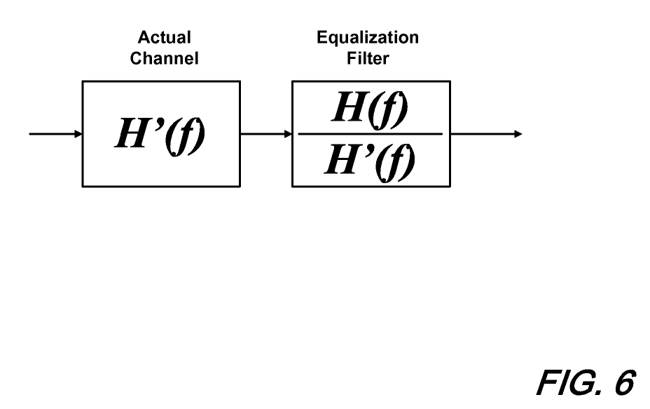

Accordingly, and with reference now to FIG. 6, if we desire a transfer function H(ƒ) and the channel has a transfer function H′(ƒ) which is different from H(ƒ), a simple method is to cascade with the channel an equalization filter which has a transfer function equal to H(ƒ)/H′(ƒ). Here the actual channel transfer function H′(ƒ) appears in the denominator of the equalization filter. Therefore, there will be noise amplification at frequencies at which H′(ƒ) is small, and this will degrade performance. One advantage of an equalization filter is its relative ease of implementation while many other advanced equalization methods rely on complicated algorithm and expensive high-speed electronics.

In the optical DWDM transmission systems that was shown previously in FIG. 3(A), AWGs and optical interleavers are major contributors to channel bandwidth limitations. Fortunately, the design of an optical equalization filter can be based on the combined filtering characteristics of the AWGs and interleavers.

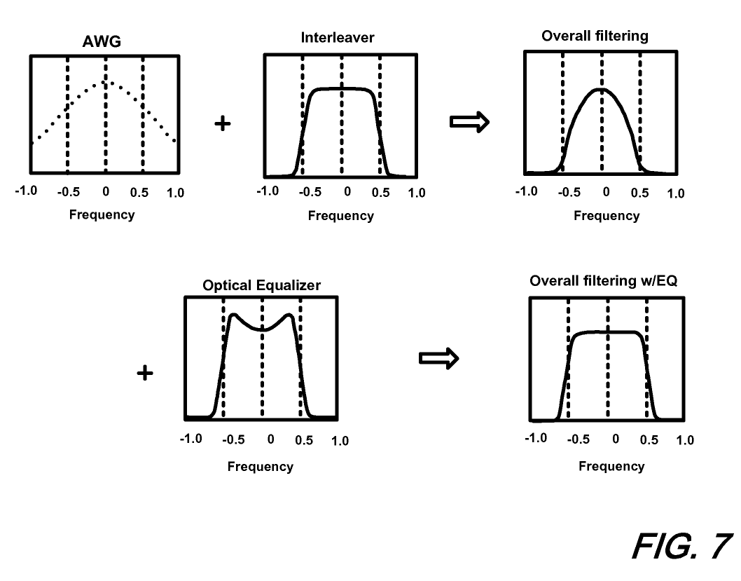

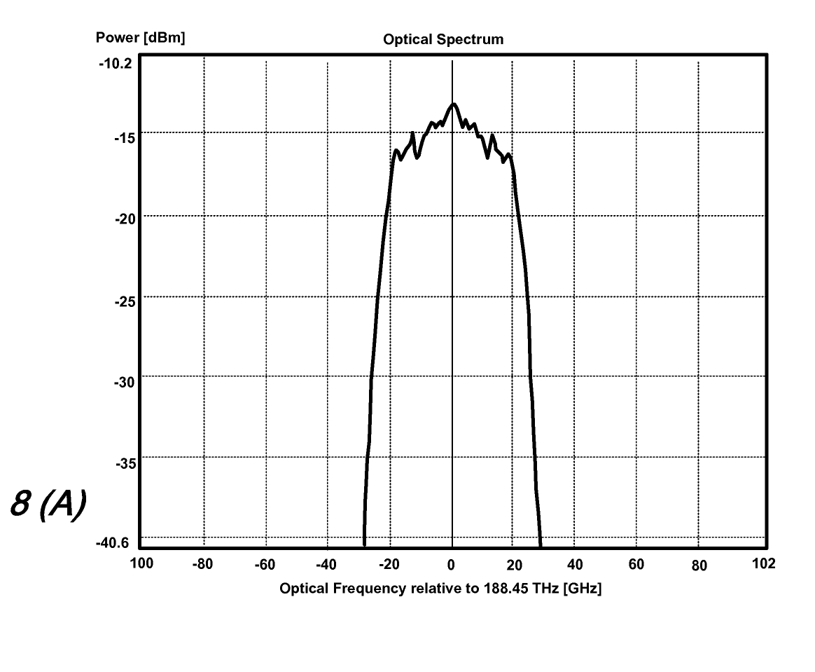

As can be readily appreciated by those skilled in the art, the overall filtering characteristics of an optical equalizer should be close to the shape of Raised-cosine. This basic principle of operation is shown pictorially in FIG. 7.

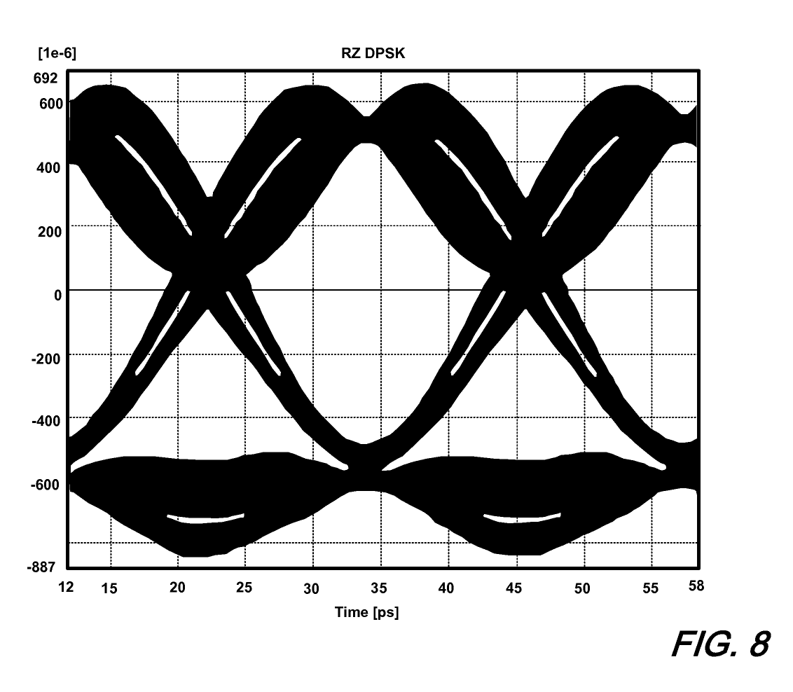

From this FIG. 7, it should be understood that equalization filters may advantageously be placed at a transmitter and a receiver to compensate any filtering attributable to the optical multiplexer and demultiplexer, respectively. For a 43 Gb/s optical signal, a received DPSK signal is shown graphically in FIG. 8. As can be observed from this FIG. 8, and as compared with FIG. 5(C) the eye diagram shown in FIG. 8 has much smaller amplitude jitter at the central sampling point. Accordingly, with good timing control and synchronization, the signal in FIG. 8 can be expected to achieve good bit error rate (BER) performance.

Optical Equalization Filters for ISI Suppression in Multiple DWDM Channels

According to the present invention, it is preferable to employ a single optical equalization filter which can advantageously suppress ISI in multiple DWDM channels. In other applications, such an optical equalization filter may be advantageously applied to transponders at different wavelengths, which has the significant effect of reducing device inventory.

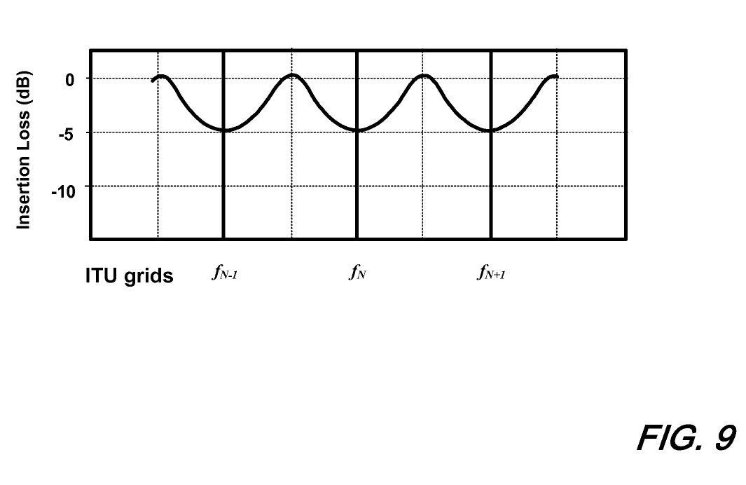

From the foregoing, we can see the transmission curve within the passband of each DWDM channel is critical for an optical equalization filter. Therefore, a periodic comb filter, shown in FIG. 9 can be used for simultaneous suppression of ISI in multiple DWDM channels. Within a passband around an ITU grid, the transmission curve is designed for the compensation of the filtering from optical multiplexer and demultiplexer to generate an overall Raised-cosine transmission curve. Advantageously, optical comb filters such as those depicted in FIG. 9 can be made with Mach-Zehnder interferometers, Febry-Perot (FP) inteferometers, fiber Bragg gratings, optical loop mirrors, or equivalent.

By way of example, we may show the working principles of a FP interferometer and its application as an optical equalization filter according to the present invention.

Febry-Perot Interferometer

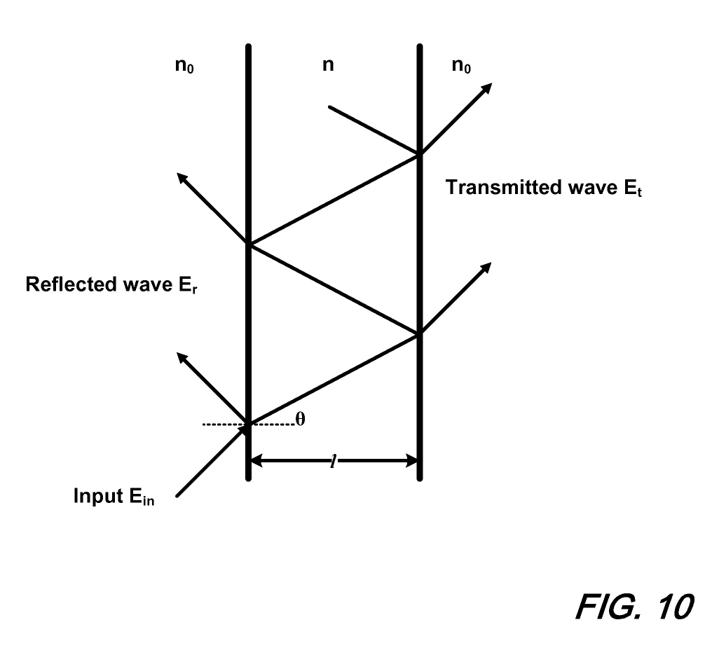

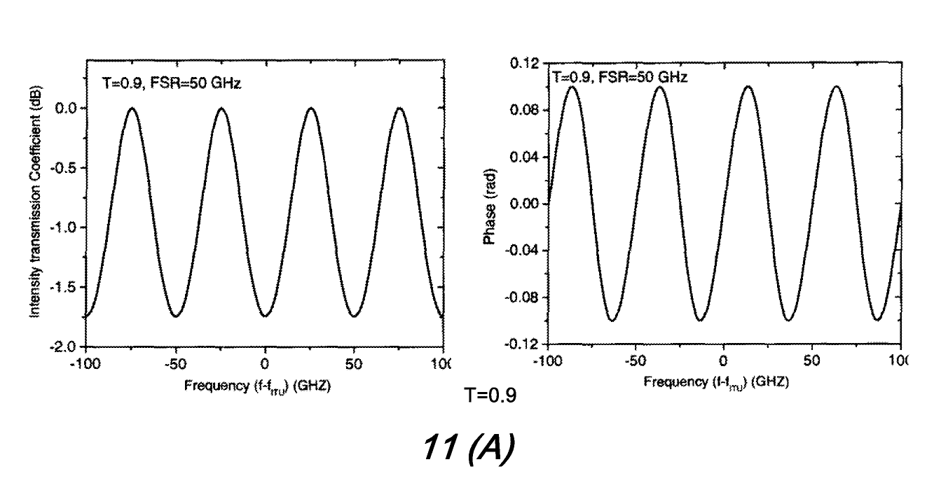

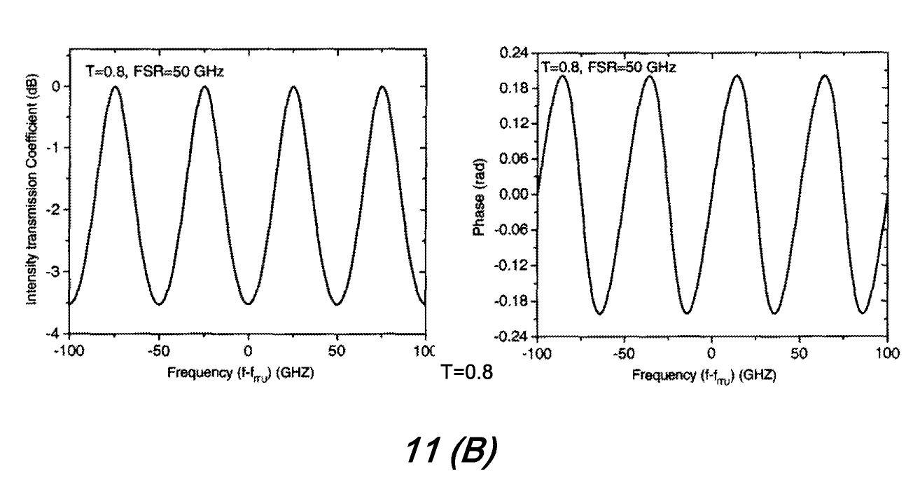

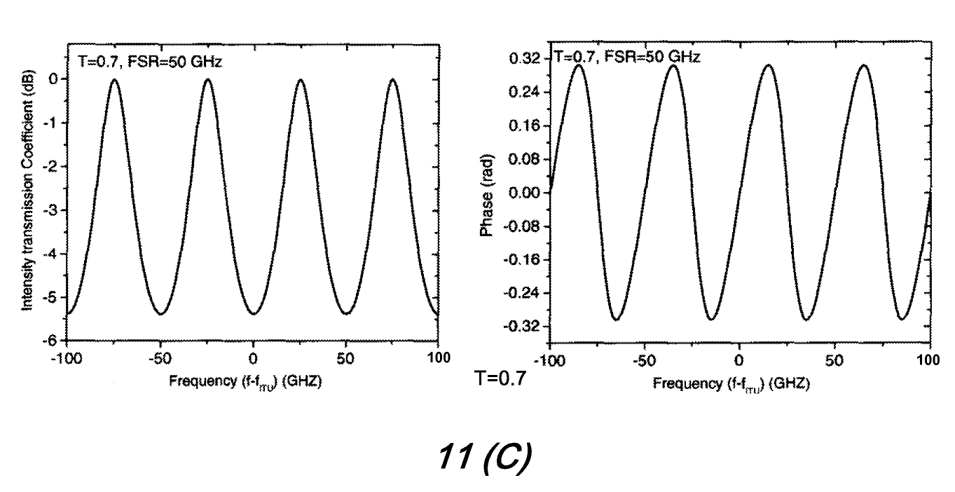

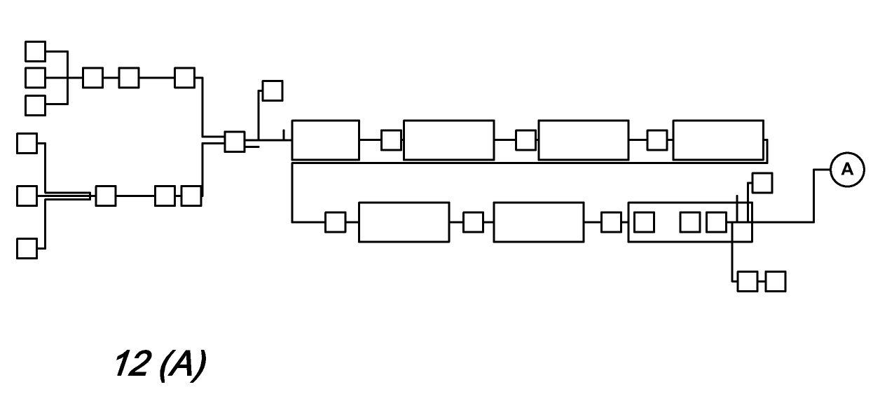

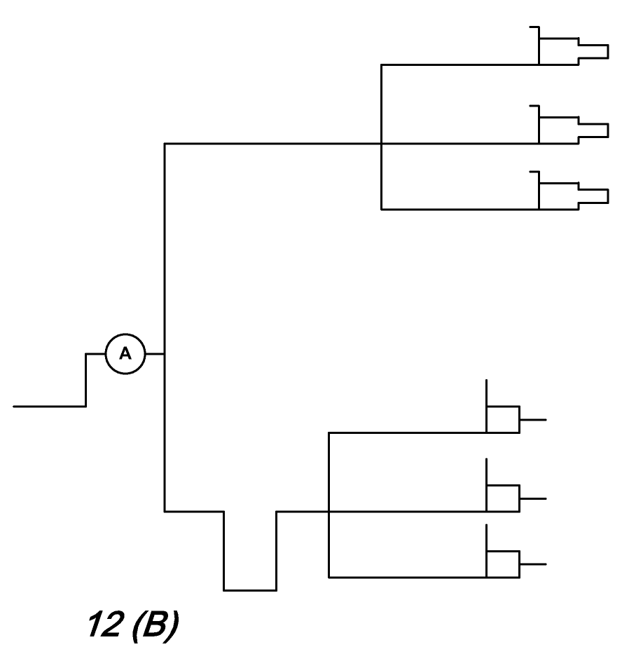

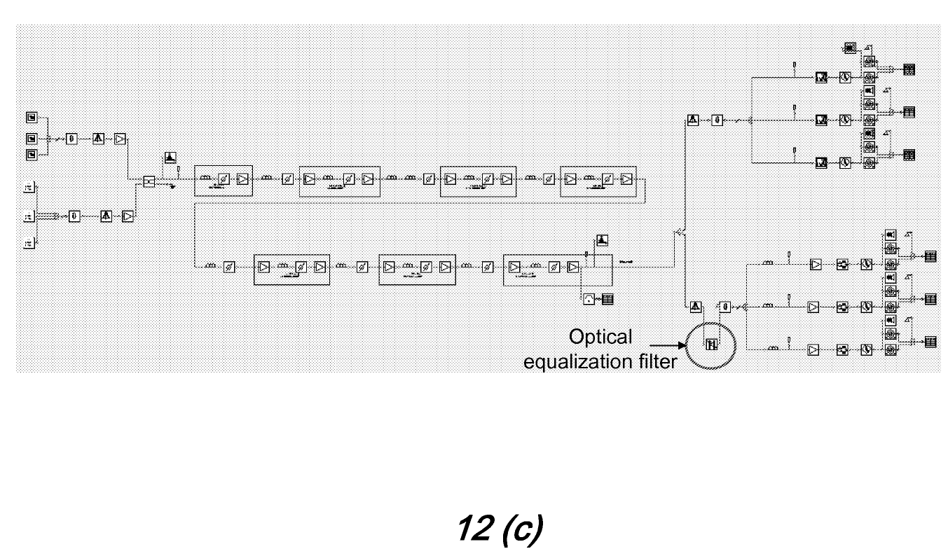

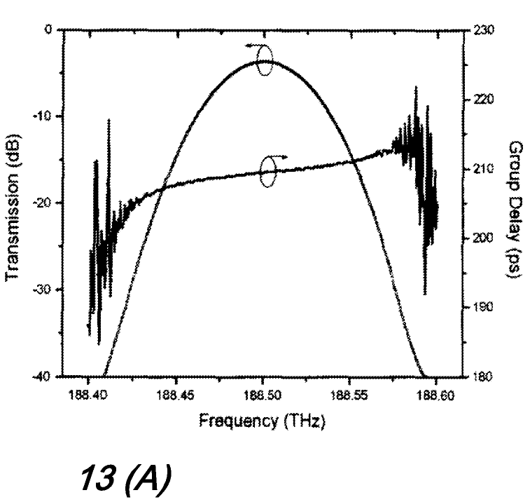

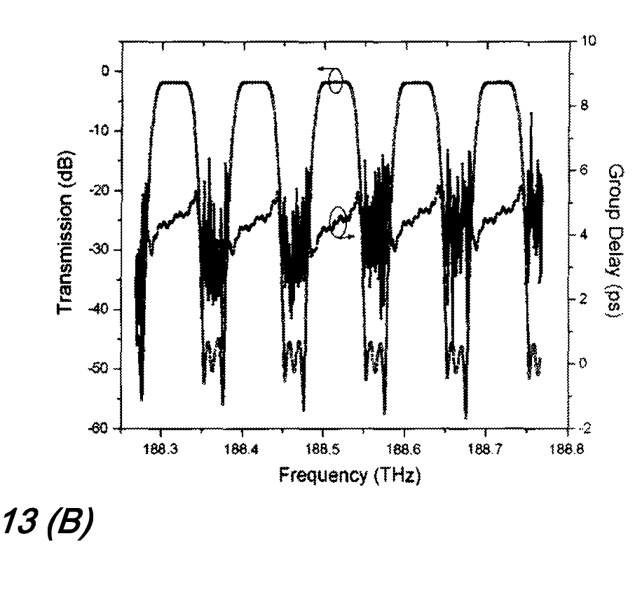

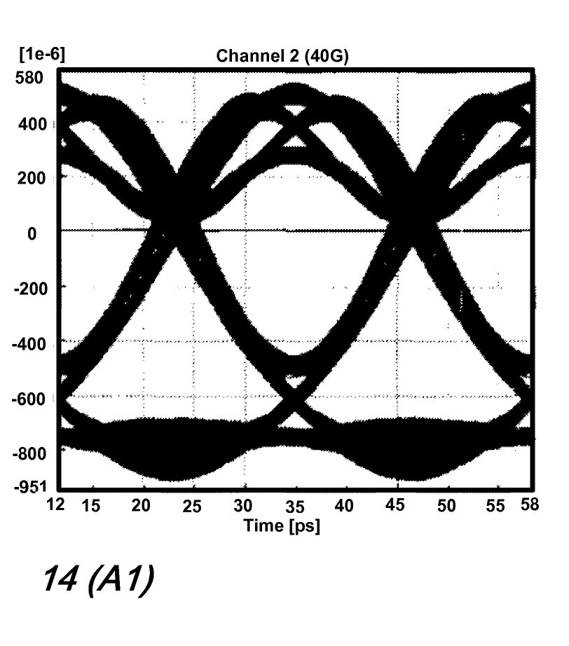

The Fabry-Perot (FP) interferometer or etalon, consists of a plane-parallel plate having thickness l and index n that is surrounded by a medium of index n₀, as shown schematically in FIG. 10. At its boundaries the electrical field is transmitted as well as reflected. The transmitted wave Eₜ and the reflected wave Eᵣ are described by the following relationships:

$$\begin{matrix}{E}_{t} = \frac{{tt}^{′}}{1 - {r}^{′ 2} {ⅇ}^{- j2π \frac{f - {f}_{C}}{FSR}}} \\ and & [ 7 ] \\ {E}_{r} = ( r + \frac{{tt}^{′} {r}^{′} {ⅇ}^{- j 2 π \frac{f - {f}_{C}}{FSR}}}{1 - {r}^{′ 2} {ⅇ}^{- j 2 π \frac{f - {f}_{C}}{FSR}}} ) {E}_{i} & [ 8 ]\end{matrix}$$

where the free spectral range FSR is described as:

$$FSR = \frac{c}{2 nl cos θ} \qquad [ 9 ]$$

and r is the reflection coefficient, t is the transmission coefficient for waves incident from n₀ toward n, and r′ and t′ are the corresponding coefficients for waves traveling from n toward n₀. ƒ_{C} is the central frequency.

For symmetric FP interferometers, we have r′=−r, R=r²=r′², T=tt′. For lossless mirrors, we can get R+T=1 from conservation-of-energy relation. Therefore, Eₜ and Eᵣ can be re-written as:

$$\begin{matrix}{E}_{t} = \frac{T}{1 - R {ⅇ}^{- j 2 π \frac{f - {f}_{C}}{FSR}}} {E}_{i} \\ and & [ 10 ] \\ {E}_{r} = \frac{( 1 - {ⅇ}^{- j 2 π \frac{f - {f}_{C}}{FSR}} ) \sqrt{R}}{1 - R {ⅇ}^{- j 2 π \frac{f - {f}_{C}}{FSR}}} {E}_{i} & [ 11 ]\end{matrix}$$

and the light intensity transmission coefficients for the transmitted and reflected light are defined as:

$$\begin{matrix}\frac{{I}_{t}}{{I}_{i}} = \frac{{E}_{t} {E}_{t}^{*}}{{E}_{i} {E}_{i}^{*}} = \frac{{T}^{2}}{{T}^{2} + 4 R {sin}^{2} ( π \frac{f - {f}_{C}}{FSR} )} \\ and & [ 12 ] \\ \frac{{I}_{r}}{{I}_{i}} = \frac{{E}_{r} {E}_{r}^{*}}{{E}_{i} {E}_{i}^{*}} = \frac{4 R {sin}^{2} ( π \frac{f - {f}_{C}}{FSR} )}{{T}^{2} + 4 R {sin}^{2} ( π \frac{f - {f}_{C}}{FSR} )} & [ 13 ]\end{matrix}$$

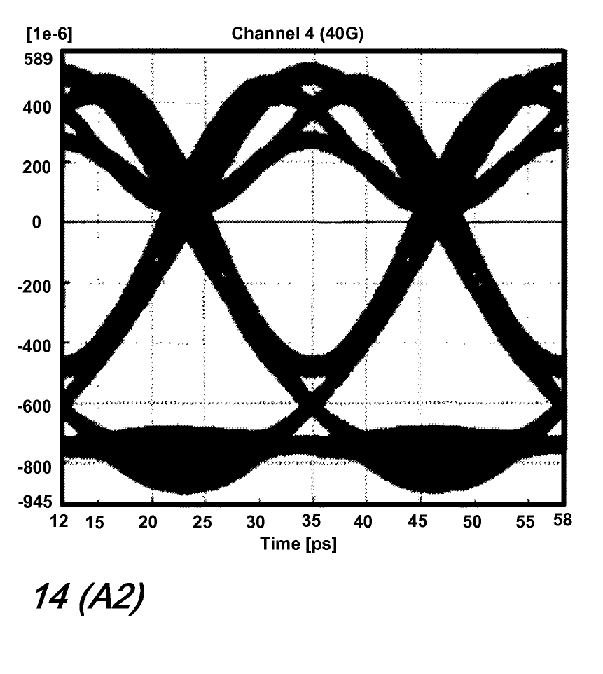

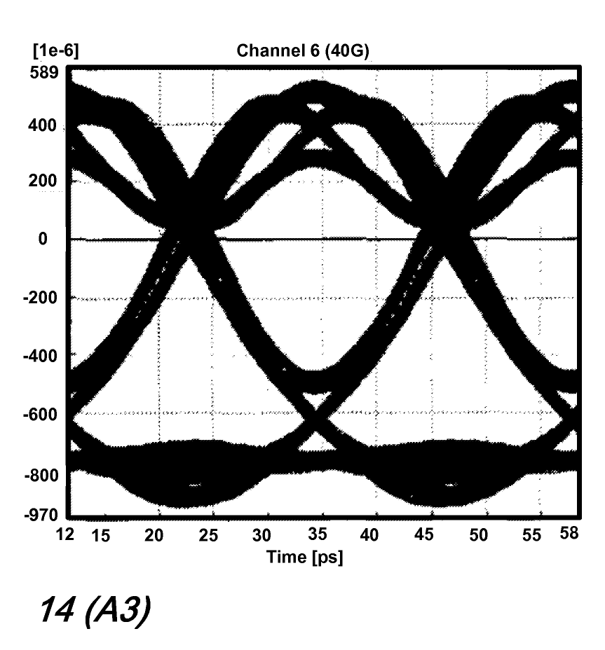

Turning now to FIG. 11, there is shown the light intensity transmission curve and phase change for different settings of mirror transmission coefficient. The depth of the transmission coefficient dip at the center of ITU wavelengths is 1.7 dB, 3.5 dB and 5.4 dB for mirror transmission coefficients of 0.9, 0.8 and 0.7, respectively. As can be readily appreciated, with smaller mirror reflectivity, there is smaller phase change for signals passing through the filter.

System Simulations with FP-Type Optical Equalization Filter

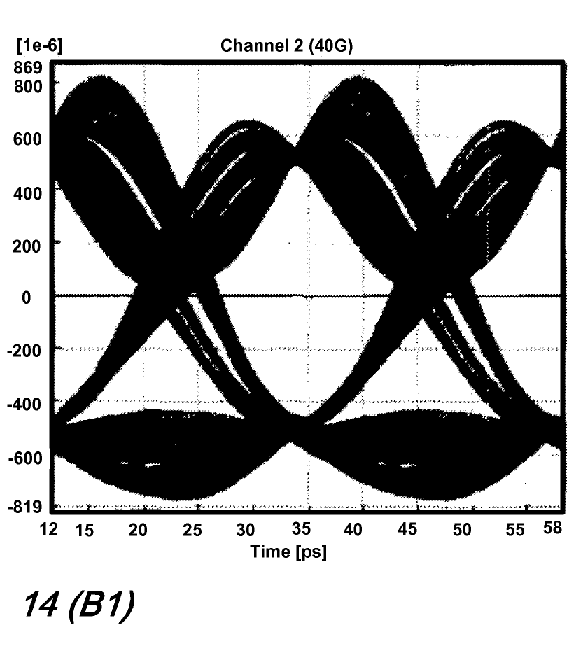

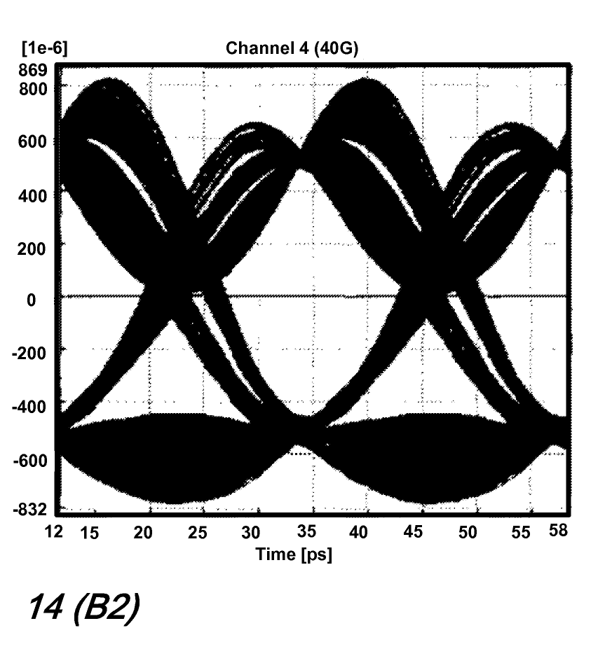

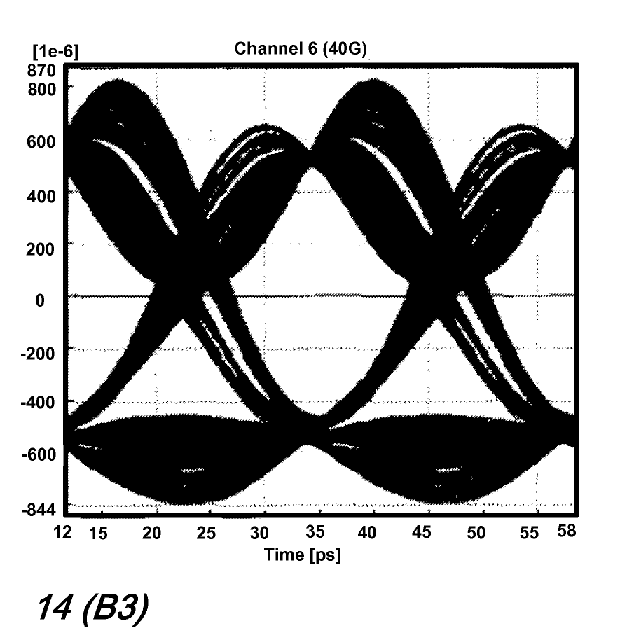

The VPI simulation layout is shown pictorially in FIG. 12. As can be seen, there are three 10.7 Gb/s channels at 188.40 THz, 188.50 THz and 188.60 THz interleaved with three 42.8 Gb/s channels at 188.35 THz, 188.45 THz and 188.55 THz. The optical multiplexer and demultiplexer used exhibit characteristics of known systems. The fiber link comprises six spans of standard single mode fiber with total length around 500 km.

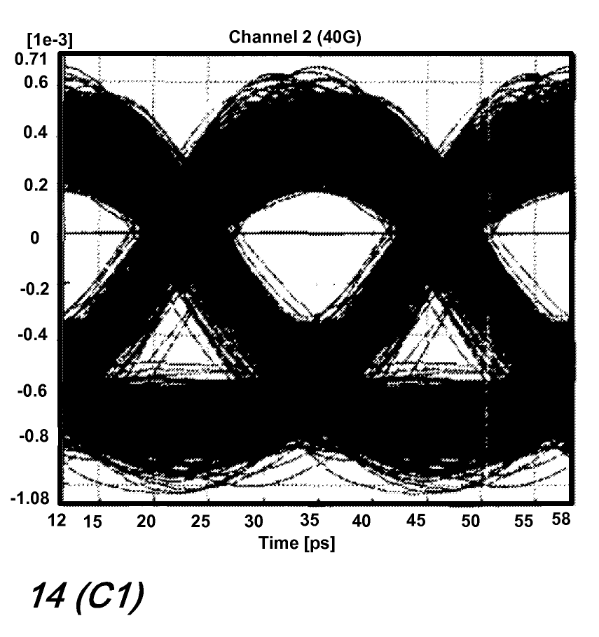

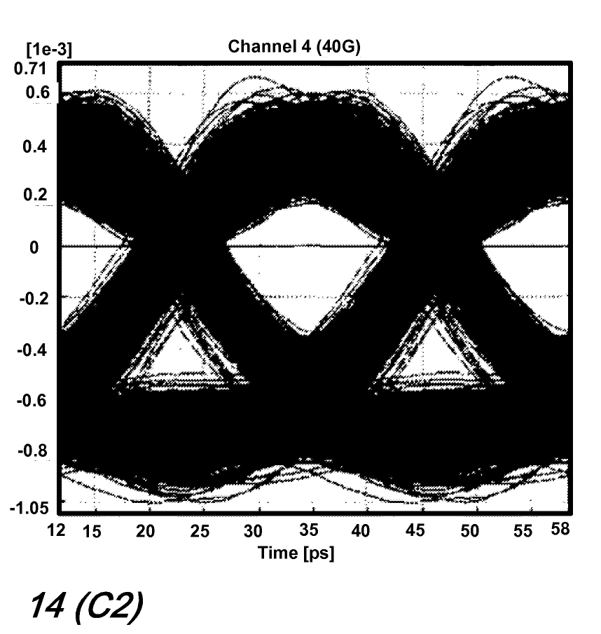

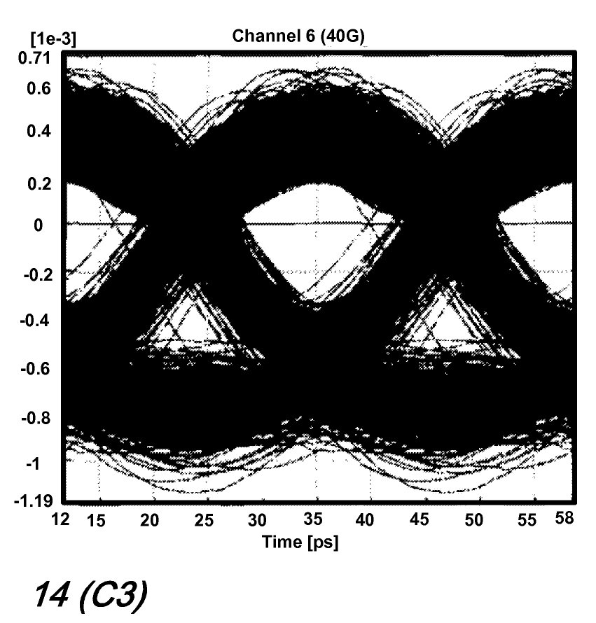

In the simulation, an optical equalization filter is positioned before all of the 42.8 Gb/s DPSK channels. The optical equalization filter is based on a FP interferometer, and the mirror transmission coefficient is set to be 0.7, which results in 5.4 dB dip depth in the filtering curve. The central frequency for the FP interferometer is 188.425 THz, and the FSR is 50 GHz. The intensity transmission and group delay curves of the AWG and optical interleaver used in the simulation are shown in FIG. 13. The AWG has a Gaussian shape with 3 dB bandwidth about 70 GHz. The optical interleaver has a flattop passing band.

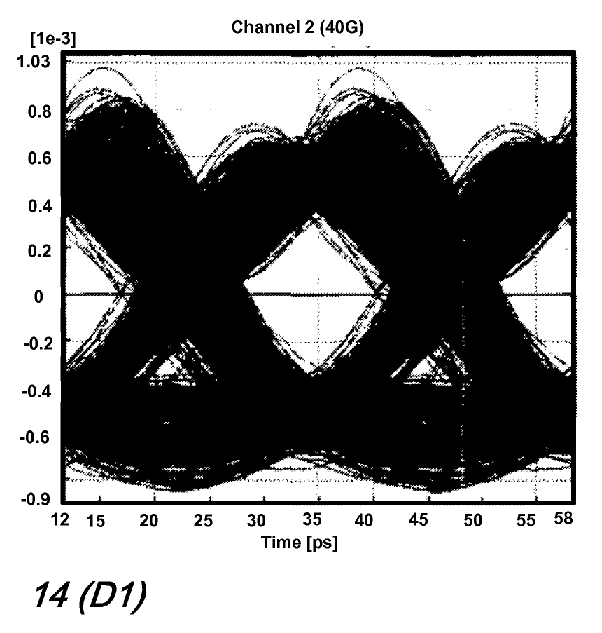

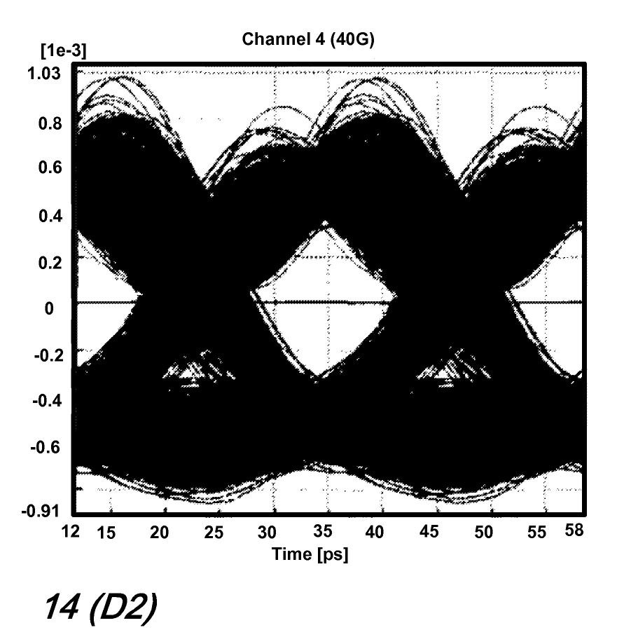

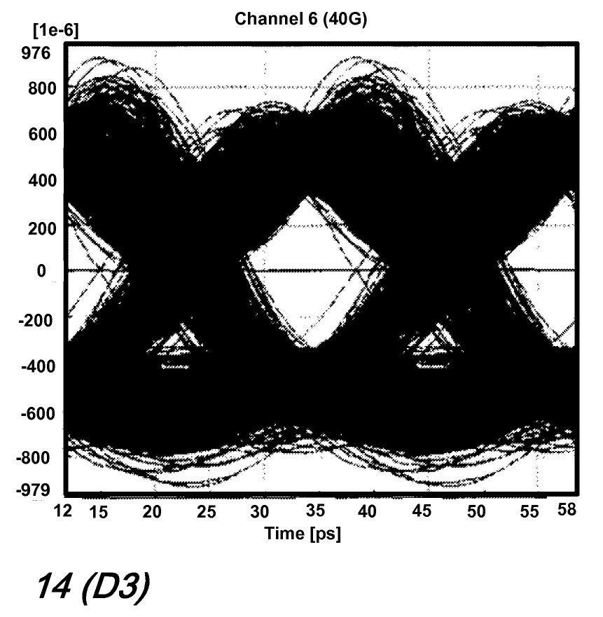

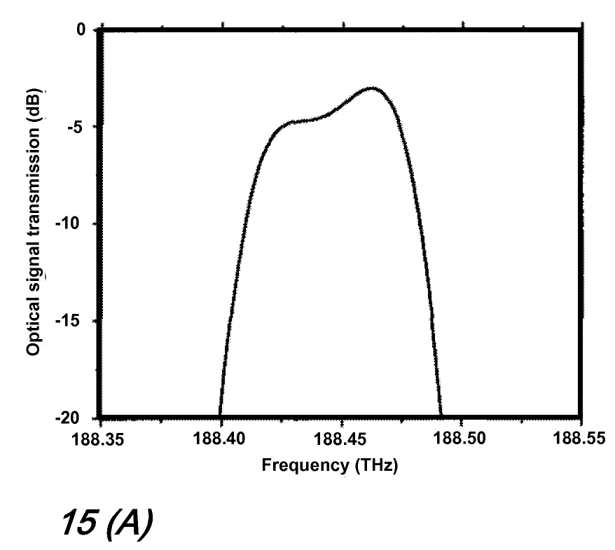

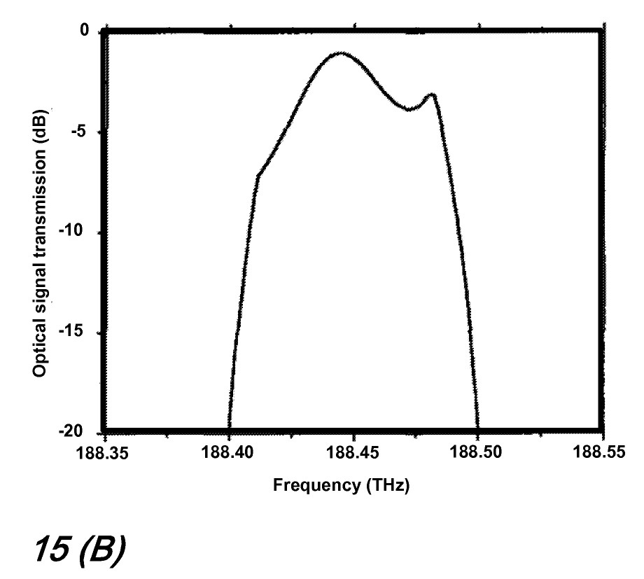

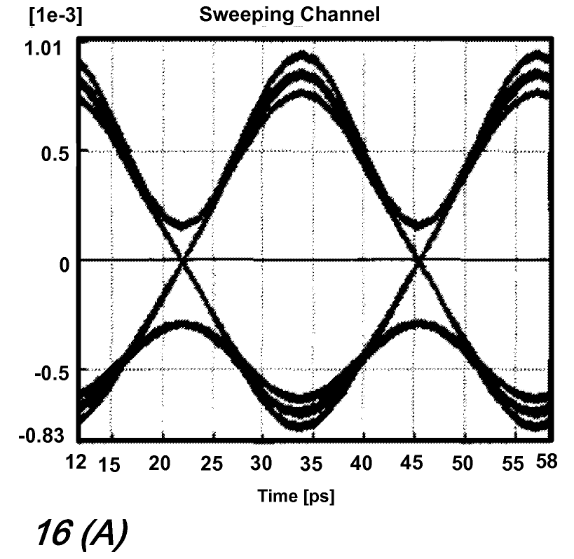

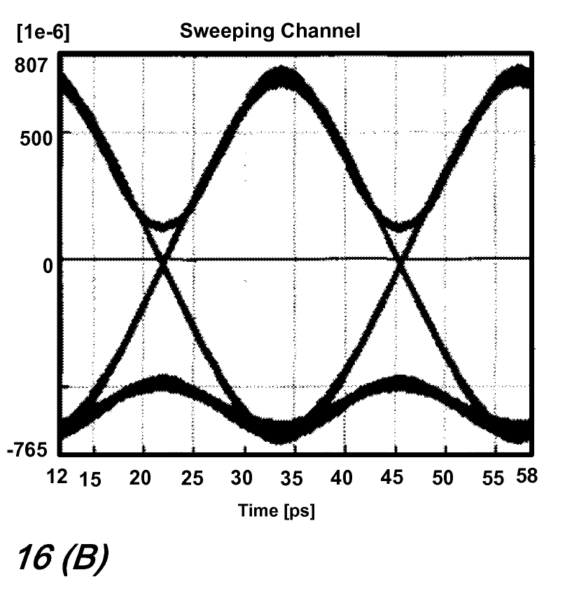

The simulated eye diagrams of the received 42.8 Gb/s RZ DPSK signals are shown in FIG. 14. Without optical equalization, the Q factors for the back-to-back signals are 13.8 dB, 14.4 dB, and 13.8 dB. With one optical equalization filter to simultaneously suppress the ISI in all the three channels, the Q factors are increased to be 19.8 dB, 22.9 dB, and 23.1 dB. In back-to-back measurements, the signal Q factors can be increased more than 6 dB. After ˜500 km transmission, the signal Q factors for the three 42.7 Gb/s DWDM channels are 12.3 dB, 12.5 dB and 12.1 dB. With optical equalization filters, the signal Q factors are increased by ˜3 dB to be 15.4 dB, 15.4 dB, and 15.2 dB. For the signals after optical equalization shown in FIG. 14, the eye diagrams become asymmetrical. This is likely due to the dispersion caused by the FP-type optical equalizer.

Of course, it will be understood by those skilled in the art that the foregoing is merely illustrative of the principles of this invention, and that various modifications can be made by those skilled in the art without departing from the scope and spirit of the invention. Accordingly, the invention is to be limited only by the scope of the claims attached hereto.

What is claimed is:

1. In a dense wavelength division multiplexed (DWDM) optical transmission system including a transmitter having an optical multiplexer, a receiver having an optical demultiplexer, and an optical link optically interconnecting the transmitter and the receiver, a method of suppressing inter-symbol interference (ISI), said method comprising the steps of:
generating, the DWDM signal;
transmitting the DWDM signal at the transmitter; and
receiving the DWDM signal at the receiver and
filtering through the effect of an equalization filter the DWDM signal such that an entire channel of the DWDM system exhibits a raised cosine function.

2. The method according to claim 1 wherein said equalization filter is a Fabry-Perot type filter.

3. The method according to claim 1 wherein said DWDM system includes a plurality of channels and each of said channels exhibits a raised cosine functions.

4. The method according to claim 1 further comprising the step of:
Positioning the equalization filter at an optical location in the system prior to the location of the optical multiplexer.

5. The method according to claim 1 further comprising the step of:
Positioning the equalization filter at an optical location in the system after the optical demultiplexer.

6. The method according to claim 1 further comprising the step of:
positioning the equalization filter such that it is interposed between the transmitter and the optical link.

7. The method according to claim 1 further comprising the step of:
positioning the equalization filter such that it is interposed between the optical link and the receiver.

8. The method according to claim 1 wherein said transmitter includes one or more arrayed waveguide grating multiplexers and an optical interleaver, said method further comprising the step of:
positioning the equalization filter such that it is interposed between the arrayed waveguide grating and the optical interleaver.

9. The method according to claim 1 wherein said receiver includes one or more arrayed waveguide grating multiplexers and an optical deinterleaver, said method further comprising the step of:
positioning the equalization filter such that it is interposed between the arrayed waveguide grating and the optical deinterleaver.
